(19) United States
(12) Patent Application Publication
(10) Pub. No.: US 2021/0405610 A1
(43) Pub. Date: Dec. 30, 2021

(54) Maintenance Recommendation System and Maintenance Recommendation Method

(71) Applicant: Hitachi, Ltd., Tokyo (JP)

(72) Inventors: Takayuki UCHIDA, Tokyo (JP); Tomoaki MORIOKA, Tokyo (JP); Takashi YOKOHARI, Tokyo (JP); Yasuharu NAMBA, Tokyo (JP)

(21) Appl. No.: 17/183,466

(22) Filed: Feb. 24, 2021

(30) Foreign Application Priority Data
Jun. 30, 2020 (JP) 2020-112881

(51) Int. Cl. G05B 19/4063; G06Q 10/00

(52) U.S. Cl. CPC G05B 19/4063; G05B 2219/45045; G05B 2219/32224; G06Q 10/20

(57) ABSTRACT

The present invention provides maintenance recommendation system and method that improve the accuracy of estimating a failure mode of equipment and thereby reduce frequency of replacement operations, shorten a time of examination, and decrease a recovery time of equipment from a failure. A maintenance recommendation system of the present invention identifies a failure mode of a machine and comprises an information input element to input one or more inspection results required to identify a failure mode, a temporary storage unit to store the inspection results, a failure mode probability calculating unit to estimate probabilities of failure modes from results of inspection performed one or more times, and an estimation-accuracy determining unit to calculate uncertainty of the probabilities of the failure modes. The system presents inspection items based on the uncertainty of the probabilities of the failure modes.

### CLAIM OF PRIORITY

The present application claims priority from Japanese Patent Application JP 2020-112881 filed on Jun. 30, 2020, the content of which is hereby incorporated by reference into this application.

### BACKGROUND OF THE INVENTION

The present invention relates to a maintenance recommendation system and a maintenance recommendation method for assisting equipment maintenance work by recommending what should be inspected to identify a failure mode when equipment has failed and estimating a failure mode from results of inspection.

Equipment maintenance work is necessary to ensure constant operation of equipment such as gas engines, elevators, and mining/building equipment. Especially, when equipment has failed to stop, it is required to examine what failure has occurred, take action, and recover the equipment operation. For examination, it is important to inspect the components of the equipment and identify a failure mode that is a state of the equipment causing the failure.

To solve this problem, e.g., an invention for automatically identifying a failure mode is found in a document JP 2009-223362. The document JP 2009-223362 introduces a technique that estimates what failure mode occurs now based on probability, using a model in which probabilities of failures are defined with respect to each of the states of equipment components and equipment user operation histories. The probabilities of failures are estimated from knowledge and experience of equipment designers, daily failure reports, etc. and set in the model. The document JP 2009-223362 additionally discloses a technique that enables ad hoc updating according to the actual situation of failure occurrence circumstances in the market by updating the occurrence probability of a failure mode for which occurrence frequency has exceed a certain value.

In daily failure reports that are a source of information to estimate probabilities of failures, there is often none of written information of what inspection was performed for equipment when a failure mode was found. This is because working hours for each on-site maintenance work is limited and reporting what inspection was performed is not necessarily obligatory, though there is an obligation to report “what failure mode occurs and what action was taken?”

Nevertheless, with regard to failure modes whose occurrence frequency is high and for which there is a large quantity of daily failure reports, it is likely that a necessary quantity of daily reports in which inspection items are written can be gathered, though such failure modes are a low proportion. However, it is hard to gather inspection items regarding failure modes whose occurrence frequency is low. Therefore, it is difficult to increase the accuracy of estimating a failure mode whose occurrence frequency is low.

### SUMMARY OF THE INVENTION

The present invention is intended to provide a maintenance recommendation system and a maintenance recommendation method that improve the accuracy of estimating a failure mode of equipment and thereby reduce frequency of replacement operations, shorten a time of examination, and decrease a recovery time of equipment from a failure.

According to one aspect of the present invention, a maintenance recommendation system identifies a failure mode of a machine and comprises an information input element to input one or more inspection results required to identify a failure mode, a temporary storage unit to store the inspection results, a failure mode probability calculating unit to estimate probabilities of failure modes from results of inspection performed one or more times, and an estimation-accuracy determining unit to calculate uncertainty of the probabilities of the failure modes, wherein the system presents inspection items based on the uncertainty of the probabilities of the failure modes.

According to another aspect of the present invention, a maintenance recommendation system identifies a failure mode of a machine and comprises a terminal and a center system that is connected with the terminal via communications. The terminal includes a display unit, an input unit, and a communication unit. The center system includes an information input unit to input, via the communication unit, one or more inspection results required to identify a failure mode, the inspection results being input through the input unit of the terminal, a temporary storage unit to store the inspection results, a failure mode probability calculating unit to estimate probabilities of failure modes from results of inspection performed one or more times, and an estimation-accuracy determining unit to calculate uncertainty of the probabilities of the failure modes, and wherein the terminal inputs, via the communication unit, inspection items obtained based on the uncertainty of the probabilities of the failure modes in the center system and displays the inspection items on the display unit.

According to another aspect of the present invention, a maintenance recommendation method identifies a failure mode of a machine and comprises the steps of estimating probabilities of failure modes from one or more inspection results required to identify a failure mode, calculating uncertainty of the probabilities of the failure modes, and presenting inspection items which have a high degree of the uncertainty of the probabilities of the failure modes, thereby prompting a maintenance person to inspect the inspection items which have a high degree of the uncertainty of the probabilities of the failure modes.

According to the present invention, the accuracy of estimating a failure mode of equipment is improved and thereby frequency of replacement operations, a time of examination, and a recovery time of equipment from a failure are decreased.

### BRIEF DESCRIPTION OF THE DRAWINGS

FIG. 1 is a diagram depicting an overall configuration example of a maintenance recommendation system pertaining to an embodiment of the present invention;

FIG. 2 is a diagram presenting a data structure example of an inspection item probability table;

FIG. 3 is a diagram presenting a data structure example of a failure mode probability table;

FIG. 4 is a diagram presenting a data structure example of a temporary storage unit;

FIG. 5 is a flowchart illustrating a main routine of maintenance recommendation processing pertaining to a first embodiment of the present invention;

FIG. 6 is a flowchart illustrating detailed subroutine processing of a processing step S710;

FIG. 7 is a flowchart illustrating detailed subroutine processing of a processing step S730;

FIG. 8 is a flowchart illustrating detailed subroutine processing of a processing step S750;

FIG. 9 is a diagram presenting an initial screen example displaying all inspection items on a terminal;

FIG. 10 is a diagram presenting a display screen example displaying uninspected inspection items obtained as a result of processing at a processing step S905;

FIG. 11 is a diagram presenting a display screen example in which inspection items with the highest level of correlation with a failure mode are searched for and displayed;

FIG. 12 is a diagram presenting a display screen example displaying failure modes with top N ranks of probability for which reliability is secured; and

FIG. 13 is a diagram illustrating a concept of a Bayesian network.

### DETAILED DESCRIPTION OF THE PREFERRED EMBODIMENTS

In the following, a maintenance recommendation system and a maintenance recommendation method according to an embodiment of the present invention will be described in detail with reference to the drawings. Note that equipment subject to inspection in the embodiment is assumed to be a refrigerator with a vapor-compression freezer as an example.

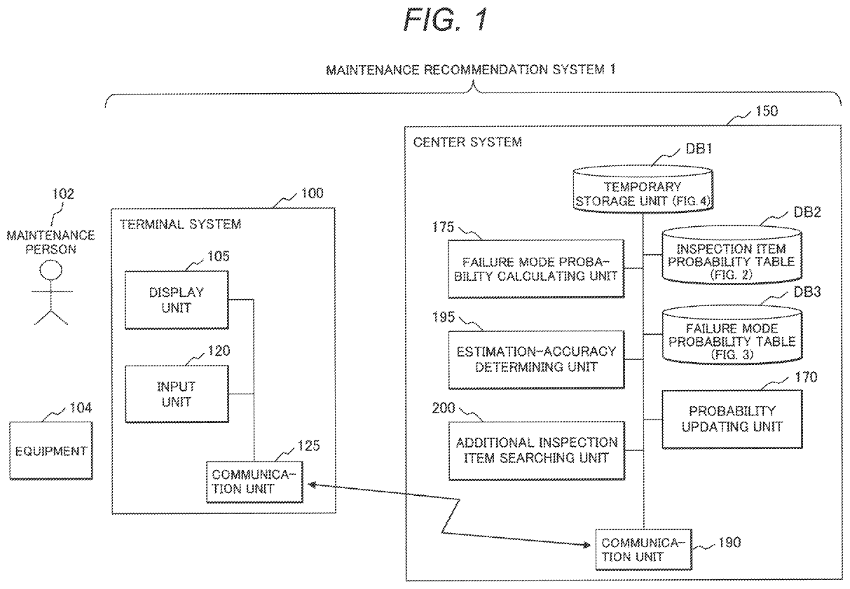

FIG. 1 depicts an overall configuration example of a maintenance recommendation system 1 pertaining to an embodiment of the present invention. The maintenance recommendation system 1 generally treats faulty equipment 104 to be repaired by a maintenance person 102 as the equipment subject to diagnostic inspection and is roughly comprised of a terminal 100 for the maintenance person 102 to perform a failure examination and a center system 150 that connects with the terminal 100 via communications.

The terminal 100 is preferably a lightweight tablet or the like that is easy to carry by a maintenance person 102 visiting to an equipment operating site. The terminal 100 has a display unit 105 such as a liquid crystal display, an input unit 120 comprised of, inter alia, a touch display, and a communication unit 125. Note that, in the present embodiment, it is assumed that a maintenance person 102 visits to a customer site where the equipment 104 exists and performs maintenance work and multiple maintenance persons 102 share the center system 150 and, therefore, there is separation into the terminal 100 and the center system 150. However, the terminal 100 and the center system 150 may be unified. Note that, on the display unit 105, displayed is a variety of data created in intermediate and final phases of processing that is performed by the center system 150 as well as data that has been entered by the maintenance person 102. Hence, information presented by the center system 150, which will be described later, is also displayed on the display unit 105. In response, the maintenance person 102 is prompted to perform inspection of a new inspection item presented and recommended by the center system 150.

The equipment 104 is the equipment subject to maintenance, such as generators, construction equipment, and medical equipment. By inspecting each of components of the equipment and entering a result of the inspection to the terminal 100, the maintenance person 102 can acquire an item to be next inspected and a result of failure mode estimation from the center system 150. Note that the present invention can be implemented by including the terminal 100 built in the equipment 104.

The center system 150 receives equipment inspection results having been input to the terminal 100 via a communication unit 190 and returns a failure mode and an item to be next inspected, i.e., an inspection item candidate to the terminal 100 held by the maintenance person 102. For this purpose, the communication unit 125 is provided within the terminal 100 and the communication unit 190 is provided within the center system 150.

The center system 150 is equipped with a temporary storage unit DB1 to store results of inspections performed by maintenance persons 102, a failure mode probability calculating unit 175 for use to estimate the probability of a failure mode, an estimation-accuracy determining unit 195 to determine whether or not the accuracy of estimating the probability of a failure mode is low, and an additional inspection item searching unit 200 to find an additional inspection item to be presented, if the accuracy is low. The center system 150 is also equipped with a probability updating unit 170 to update an inspection item probability table DB2 and a failure mode probability table DB3 based on the results of inspections having been input by maintenance persons 102.

By virtue of the center system 150 described above, if a failure mode is determined as the one for which the accuracy of estimating its probability is low, an additional inspection item is presented to a maintenance person 102 and its result is input. Thereby, it is possible to increase the accuracy of estimating the probability of the failure mode. If a failure mode is the one for which there are a small number of failure samples ever obtained and, therefore, the accuracy of estimating its probability is low, a maintenance person is prompted to inspect the additional item, taking advantage of the current opportunity of inspection. By reflecting its result having been input, the number of samples increases, thus increasing the accuracy of estimating the probability.

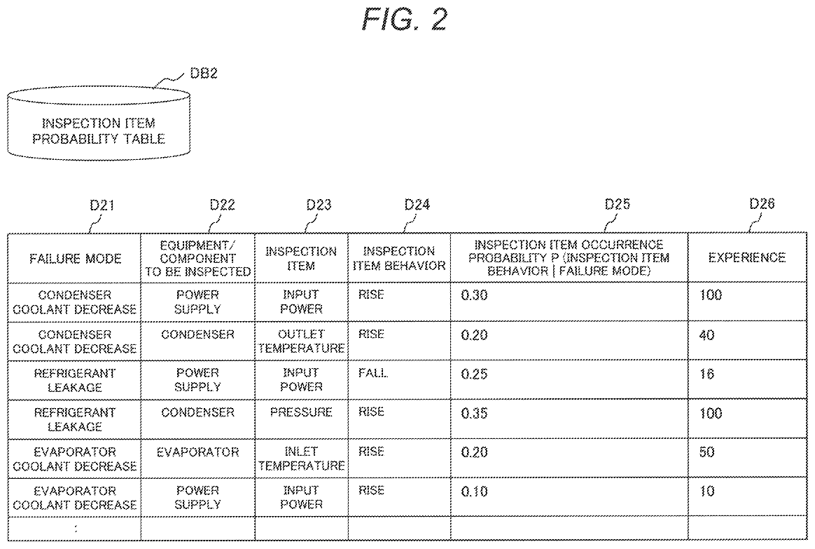

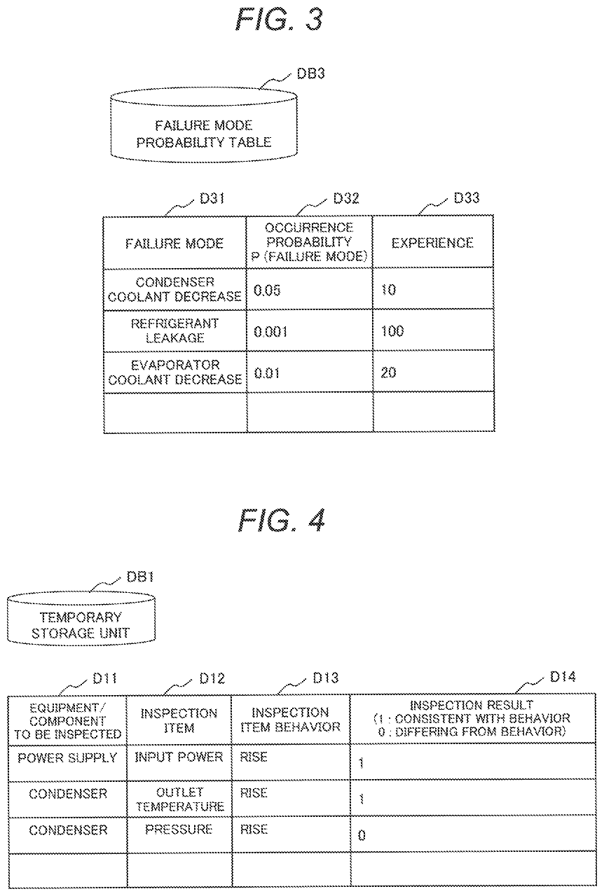

The temporary storage unit DB1 that generally has a database structure and stores temporary information D1, the inspection item probability table DB2 that stores inspection item probability data D2, and the failure mode probability table DB3 that stores failure mode probability data D3 hold data stored in the data structures as illustrated in FIG. 4, FIG. 2, and FIG. 3, respectively. In those other than the temporary storage unit DB1, initial values are defined at the time of designing the system according to the present invention.

The inspection item probability table DB2 is configured in a data structure table which is exemplified in FIG. 2. The table is made up of data described in a field of failure mode D21, a field of equipment/component to be inspected D22, a field of inspection item D23, a field of inspection item behavior D24, a field of inspection item occurrence probability D25, and a field of Experience D26. Note that, in the following context, descriptions are provided assuming that reference symbols (D21 to D26) marking the respective fields mean what attributes of information described in these fields, unless it is necessary to distinguish between the fields and the attributes especially. In this regard, reference symbols shall be interpreted in the same manner also in other tables, the inspection item probability table DB2 and the failure mode probability table DB3.

This table is a table having stored therein, for each failure mode D21, a probability D25 by which the relevant inspection item D23 behaves as described for the inspection item behavior D24 when such failure has occurred. This probability D25 is a conditional probability in statistical terms and can be paraphrased into a conditional probability P by which the behavior D24 occurs when the failure mode D21 occurs (inspection item behavior=True|failure mode=True).

For example, data contained in a first row of the table in FIG. 2 means that, when a failure mode D21, condenser coolant decrease has occurred, a probability D25 by which an inspection item D23, input power of the power supply rises is 0.30. Likewise, data contained in a second row of the table indicates that, when the failure mode D21, condenser coolant decrease has occurred, a probability D25 by which an inspection item D23, condenser outlet temperature rises is 0.20. Data contained in a third and subsequent rows is described to mean like things, though a further description is omitted.

This probability may be not necessarily a precise value. For instance, it may be estimated from experience of a designer and a maintenance person of the equipment 104 or may be estimated from failure rates in a reliability database, past experimental values, or a failure simulation based on a physical model and can be input at the time of designing a system to which the present invention is applied. Estimating a failure mode can be performed from this conditional probability and the probability in the failure mode probability table in FIG. 3 which will be described subsequently.

The table in FIG. 2 holds a parameter Experience in the field D26 as the parameter indicating reliability of the probability along with the field of inspection item occurrence probability D25. This parameter is a parameter that appears in Bayesian updating when a beta distribution is adopted as a prior distribution in Bayes' statistics. This Bayesian updating and the parameter Experience D26, are described briefly below, though they are used in a conventional technique.

An initial value of the Experience D26 is determined depending on how much a value of inspection item occurrence probability D25 is reliable. For instance, the initial value is set to a greater value, if the probability is assigned based on experience of an expert engineer or definitely reliable information from a physical aspect. After the initial value is defined, the probability updating unit 170 in the center system 150 in FIG. 1 sequentially increments a data value that is stored in the Experience D26, each time the inspection item occurrence probability D25 is updated based on daily failure reports for failures that occur day by day. This is based on a thought in which the probability becomes more reliable, backed by results, as it is updated more times based on the daily failure reports.

An equation expressing a prior probability beta distribution which is commonly known is given in equation (1). A correspondence relationship between parameters a and b in equation (1) and an Experience parameter is given in equation (2). Furthermore, a value of probability in the field of inspection item occurrence probability D25 is given in equation (3). Note that B denotes a beta function in equation (1).

$$Prior probability beta distribution = \frac{1}{B ( a , b )} {{x}^{a - 1} ( 1 - x )}^{b - 1} \qquad ( 1 )$$

Experience=a+b (2)

A value of inspection item occurrence probability=a/a+b (3)

If, using this relational expression, it is defined that e=Experience parameter and p=probability by which an inspection item occurs, the beta distribution in equation (1) can be expressed as in equation (4).

$$Prior probability beta distribution = \frac{1}{B ( ep , e ( p - 1 ) )} {{x}^{ep - 1} ( 1 - x )}^{e ( p - 1 ) - 1} \qquad ( 4 )$$

The failure mode probability table DB3 is configured in a data structure table which is exemplified in FIG. 3. The table is made up of data described in a field of failure mode D31, a field of occurrence probability P (failure mode) D32, and a field of Experience D33. In this manner, failure modes D31 and their occurrence probability D32 are stored in the failure mode probability table DB3. Among them, the same failure modes as those under the header, failure mode D21 in FIG. 2 are stored under the header, failure mode D31. However, in the field of occurrence probability D32 in FIG. 3, a general probability by which each failure mode occurs is stored, instead of a conditional probability. This general probability by which each failure mode occurs can be calculated from the number of times that a failure mode has actually occurred until now or created from information such as occurrence probability described in Failure Mode and Effect Analysis (FMEA) of the equipment 104.

In addition, Experience D33 is defined also in FIG. 3 like Experience D26 is in FIG. 2. Its definition and treating it are the same as Experience D26 is in FIG. 2. Also in FIG. 3, Experience D33 is an index of how much probability is reliable and its value is to increment with updating probability based on day failure reports.

A data structure of the temporary storage unit DB1 is presented in FIG. 4. First, the temporary storage unit DB1 is embodied in a rewritable device such as RAM, unlike the inspection item probability table DB2 and the failure mode probability table DB3 described heretofore. This is because the temporary storage unit DB1 is to store a result of an item of inspection finished by a maintenance person 102 in the current site. From this inspection result, estimation is made of a failure mode and an item to be next inspected.

The temporary storage unit DB1 is configured in a data structure table which is exemplified in FIG. 4. The table is made up of data described in a field of equipment/component to be inspected D11, a field of inspection item D12, a field of inspection item behavior D13, and a field of inspection result D14. In the respective fields D11, D12, D13, and D14 as per this data structure, data contained in a row for which an inspection by maintenance person 102 is complete in the fields D22, D23, and D24 of the table in FIG. 2 is copied and stored. The inspection result D14 is a result of inspecting an item by a maintenance person 102 and a value “1” is stored if the item behaves as defined in the field D13 or a value “0” is stored if the item does not so.

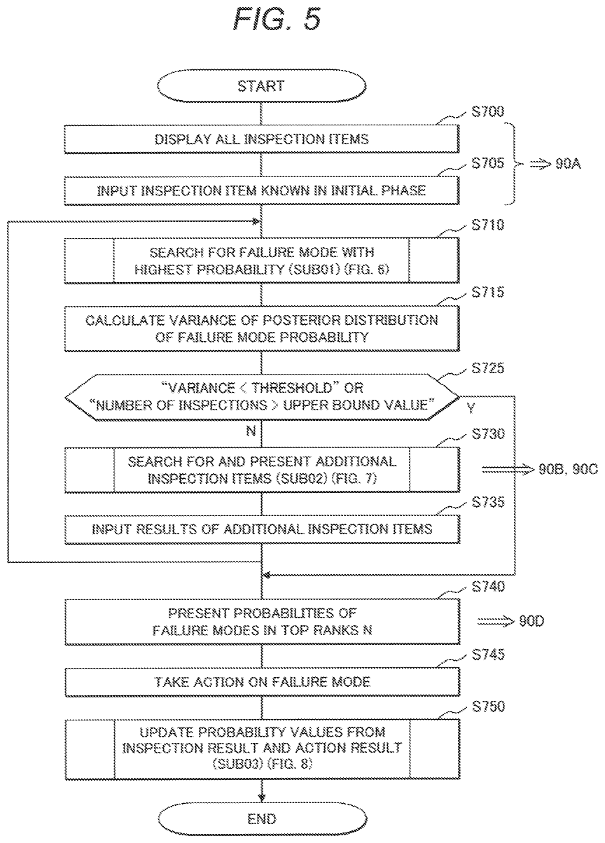

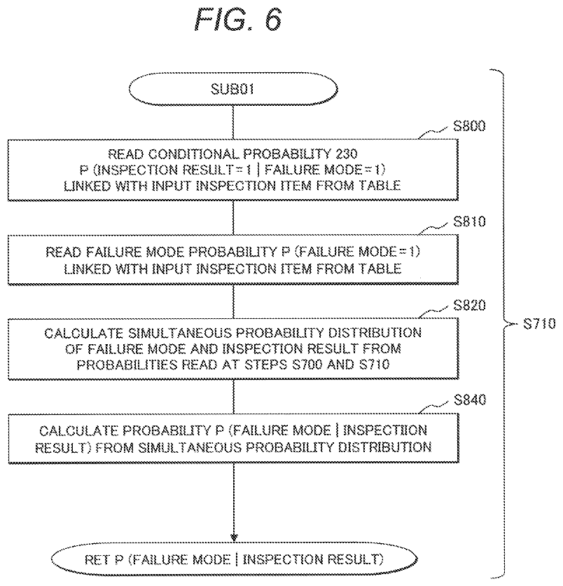

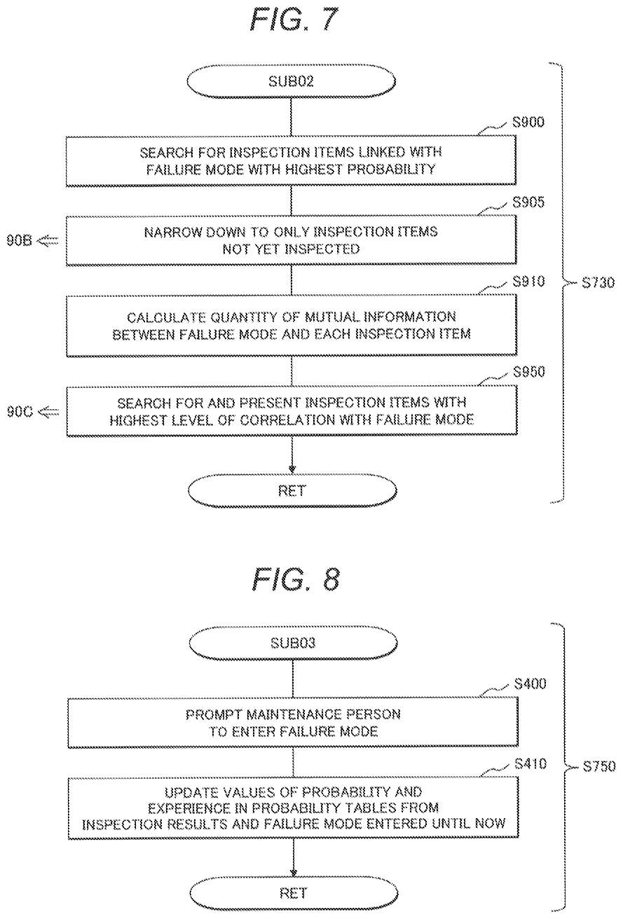

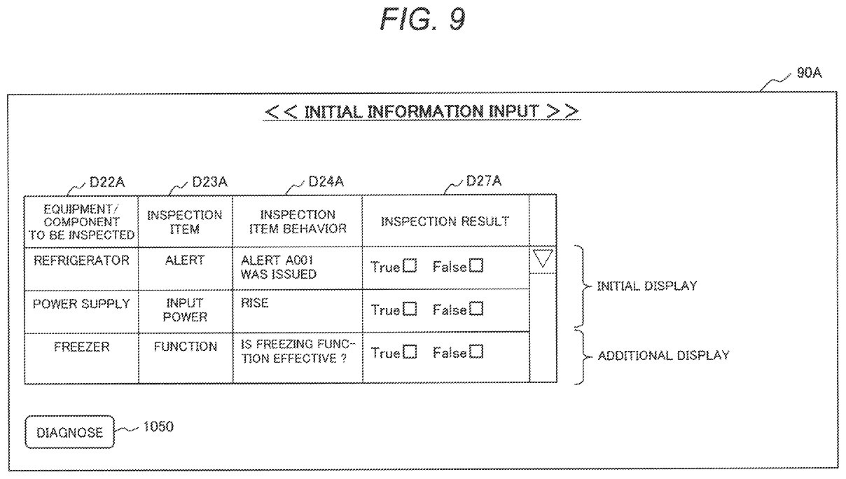

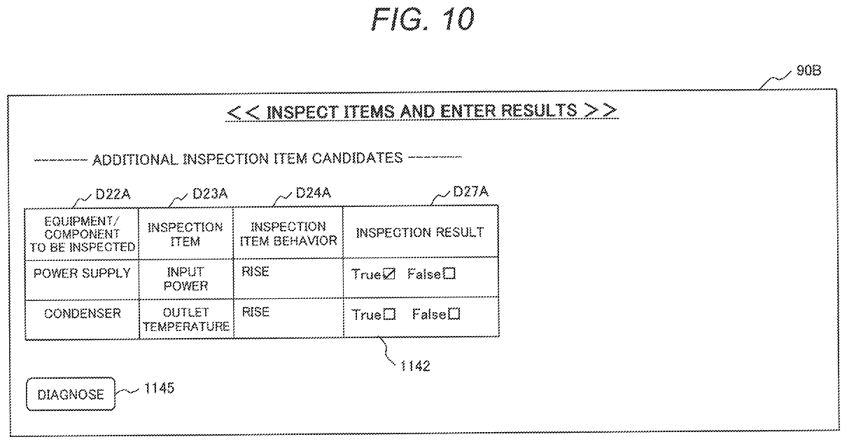

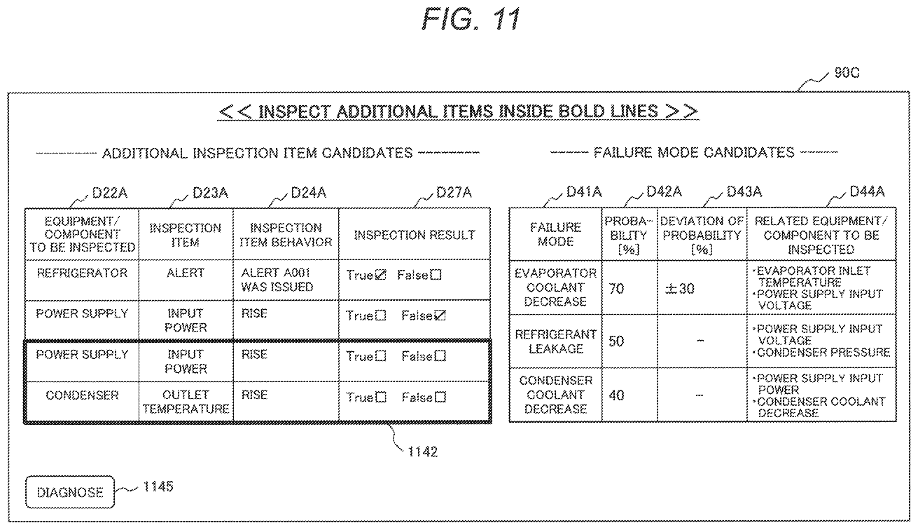

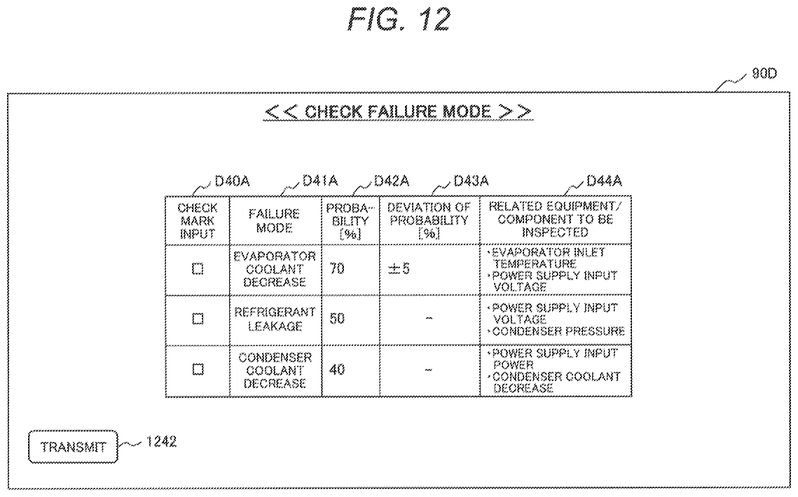

Then, processing contents of the present invention are described in detail with the aid of flowcharts in FIG. 5, FIG. 6, FIG. 7, and FIG. 8. While describing this subject, a description is provided about screen examples to be displayed which are presented in FIG. 9, FIG. 10, FIG. 11, and FIG. 12.

First, FIG. 5 is a flowchart illustrating a main routine of maintenance recommendation processing pertaining to a first embodiment of the present invention. This flowchart illustrates a procedure from the start of a work of a failure mode examination on the equipment 104 until identifying a failure mode. FIG. 6, FIG. 7, and FIG. 8 are subroutines that are called from the main routine in FIG. 5. Note that timing at which each of the screen examples in FIG. 9, FIG. 10, FIG. 11, and FIG. 12 is displayed and related descriptions are mentioned as appropriate while describing the flowcharts.

A first processing step S700 in FIG. 5 is to display all inspection items on a terminal. This step is for inputting data based on a symptom heard beforehand from the user or owner of the equipment before arrival of a maintenance person 102 to the site where the faulty equipment is placed. A way of display is reading and displaying all records of the attributes, equipment/component to be inspected D22, inspection item D23, and inspection item behavior D24 stored in the inspection item probability table DB2 in FIG. 2.

FIG. 9 presents an initial screen example 90A when displaying all inspection items on a terminal. In the initial screen example 90A, displaying read data under the headers, equipment/component to be inspected D22, inspection item D23, and inspection item behavior D24 regarding each component takes place in the corresponding display columns, D22A, D23A, and D24A. Also, in an inspection result display column D27A, checkboxes marked “True” and “False” are displayed to allow for entering a result of inspecting an item as to whether the inspection item D23 behaves as described for the inspection item behavior D24 (True) or does not so (False).

In this example, data in the first and second rows for all inspection items is assumed to have been first displayed as an initial display. In the first row, under the headers, equipment/component to be inspected D22A, inspection item D23A, and inspection item behavior D24A, “refrigerator”, “alert”, and “alert 001 was issued” are displayed respectively as an event. In the second row, under the headers, equipment/component to be inspected D22A, inspection item D23A, and inspection item behavior D24A, “power supply, “input power”, and “rise” are displayed respectively as an event.

A next processing step S705 is to input and display initial information, if exists, known before arrival of the maintenance person 102 to the site where the faulty equipment is placed in the columns of equipment/component to be inspected D22A, inspection item D23A, and inspection item behavior D24A as an additional display to the table in FIG. 9 and further put a check mark in the checkboxes in the inspection result display column D27A. If the table is displayed with a touch panel, the checkboxes can be checked by directly touching them with a finger.

As for an additional display, for instance, when there is a record with a description “alert was issued” from the equipment 104, as described in the inspection item behavior 24A in the first row of the table in FIG. 9, its related information such as “essentially, does the freezer function well?” that can be judged dispensing with special work such as disassembly of the equipment is input. For example, in this example, information “freezer” as the equipment/component to be inspected D22A, “function” as the inspection item D23A, and “is freezing function effective?” as the inspection item behavior D24A is input as an additional record in the third row.

In the initial screen example 90A in FIG. 9, a Diagnose button 1050 is displayed. When a maintenance person 102 presses this button, an inspection result is stored in the temporary storage unit DB1. If a check result is “True”, a value “1” is stored in the inspection result display column D27A; if it is False, a value “0” is stored in the inspection result display column D27A. At this time, if the inspection item D23 behaves as described for the inspection item behavior D24, “True” is checked in the inspection result display column D27A; if not so, “False” is checked.

A processing step S710 in FIG. 5 is to calculate a failure mode probability from inspection results D27 having been input at the processing step S705. A subroutine (SUB01) that represents detailed processing contents of the processing step S710 in FIG. 5 is described below with a flowchart in FIG. 6.

A first processing step S800 in FIG. 6 is to search out an inspection item D23 for which True/False has been input at the processing step S705 from the table in FIG. 2 and read P (inspection item behavior|failure mode) as the conditional probability D25 and the failure mode D21. For instance, taking note of an inspection item D23A “input power” in the second row in FIG. 9, its corresponding item is searched out from the table in FIG. 2 and P (inspection item behavior|failure mode) as the conditional probability D25 and the failure mode D21 are read. In this example, from the first row in FIG. 2, “0.30” as the conditional probability D25 and “condenser coolant decrease” as the failure mode D21 are read; from the third row in FIG. 2, “0.25” as the conditional probability D25 and “refrigerant leakage” as the failure mode D21 are read; and from the sixth row in FIG. 2, “0.10” as the conditional probability D25 and “evaporator coolant decrease” as the failure mode D21 are read.

A processing step S810 is to search out a failure mode that is the same as a failure mode D21 read at the processing step S800 by using the failure mode D31 of the failure mode probability table DB3 as a key input and read P (failure mode) from the occurrence probability D32 of the failure mode. For instance, the search extracts the first row in FIG. 3 in relation with a failure mode D21 “condenser coolant decrease” in the first row in FIG. 2 and retrieves “0.05” as P (failure mode) from the occurrence probability D32 of the failure mode. The search extracts the second row in FIG. 3 in relation with a failure mode D21 “refrigerant leakage” in the third row in FIG. 2 and retrieves “0.001” as P (failure mode) from the occurrence probability D32 of the failure mode. The search extracts the third row in FIG. 3 in relation with a failure mode D21 “evaporator coolant decrease” in the sixth row in FIG. 4 and retrieves “0.01” as P (failure mode) from the occurrence probability D32 of the failure mode. Thus, a series of pieces of information are inter-linked and extracted.

A processing step S820 is to calculate a simultaneous probability P of inspection item behavior and failure mode (multiple inspection behaviors and multiple failure modes) from multiple occurrence probabilities P (inspection item behavior|failure mode) and occurrence probabilities P (failure mode) having been read at the processing steps S800 and S810.

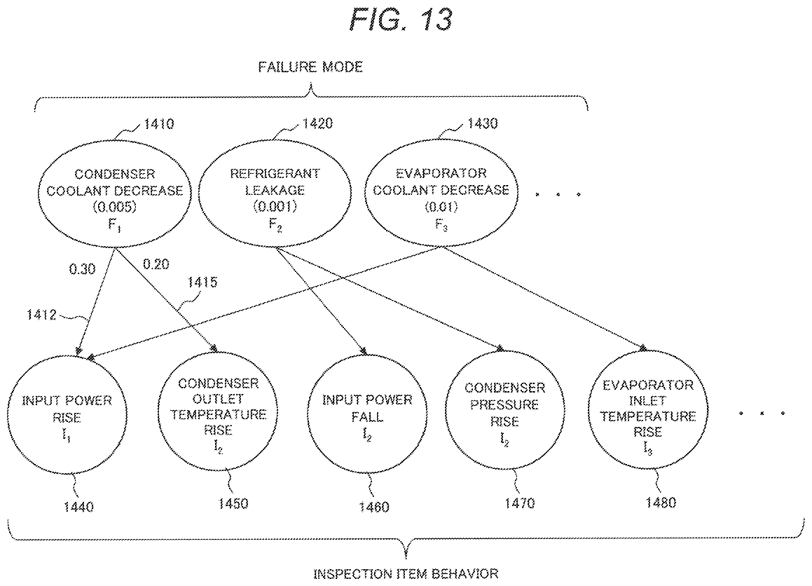

Processing at the processing step S820 can be implemented based on a conventional technique called a Bayesian network and its algorithm is described briefly. For explanation, a Bayesian network that is used in the present embodiment is depicted in FIG. 13.

FIG. 13 depicts a network in which failure modes F (1410, 1420, 1430) presented in an upper row and inspection item behaviors I (1440, 1450, 1460, 1470, 1480) presented in a lower row are inter-linked.

Among them, the failure modes F (1410, 1420, 1430) are information containing data under the headers, failure mode D31 and occurrence probability D32 in the failure mode probability table DB3 in FIG. 3. For example, a failure mode 1410 contains “condenser coolant decrease” as the failure mode D31 and “0.005” as the occurrence probability D32, a failure mode 1420 contains “refrigerant leakage” as the failure mode D31 and “0.001” as the occurrence probability D32, and a failure mode 1430 contains “evaporator coolant decrease” as the failure mode D31 and “0.01” as the occurrence probability D32.

The inspection item behaviors I (1440, 1450, 1460, 1470, 1480) correspond to pieces of information D23, D24, D25 regarding inspection items in the inspection item probability table DB2 in FIG. 2. For example, an inspection item behavior 1440 contains “input power rise” corresponding to D23 and D24, an inspection item behavior 1450 contains “condenser outlet temperature rise” corresponding to D23 and D24, an inspection item behavior 1460 contains “input power fall” corresponding to D23 and D24, an inspection item behavior 1470 contains “condenser pressure rise” corresponding to D23 and D24, and an inspection item behavior 1480 contains “evaporator inlet temperature rise” corresponding to D23 and D24.

In addition, as per the inspection item probability table DB2, “condenser coolant decrease” is described under the header, failure mode D21 in both the first and second rows, while “input power rise” and “condenser outlet temperature rise” are described respectively in these rows under the headers, inspection item and its behavior D23 and D24. This means that there is a causal relationship between the failure modes F (1410, 1420, 1430) presented in the upper row and the inspection item behaviors I (1440, 1450, 1460, 1470, 1480) presented in the lower row.

In FIG. 13, causal relationships between factors, between the upper and lower rows are indicated by arrow lines 1412, 1415, etc. extending from the upper row (failure modes) to the lower row (inspection item behaviors) and a conditional probability P from a failure mode to an inspection item behavior is affixed. A numeral “0.30” affixed, as an example, to an allow line 1412 indicating a causal relationship means that a conditional probability P (inspection item behavior failure mode) is 0.30. Also, a numeral “0.005” appended to, e.g., a failure mode 1410 means that the occurrence probability (failure mode) in FIG. 3 is 0.005.

Assuming that a simultaneous probability P (multiple inspection item behaviors and multiple failure modes) is represented in this Bayesian network in FIG. 13, this probability can be expressed by equation (5) using symbols such as F₁ standing for a failure mode and I₁ standing for an inspection item behavior. Equation (5) can be evaluated by calculating equation (6).

P(F₁=f₁,F₂=f₂, . . . ,F_{J}=f_{J},I₁=i₁,I₂=i₂, . . . ,I_{K}i_{K}) (5)

P(F₁=f₁,F₂=f₂, . . . ,F_{J}=fⱼ,I₁=i₁,I₂=i₂, . . . ,I_{K}=i_{K})=Πₖ₌₁^{K}(Π_{J=1}^{J}P(Iₖ=iₖ/F_{J}=f_{J})^{f}^{_{J}})Π_{J=1}^{J}P(F_{J}=f_{J}) (6)

Note that P (Ik=ik/Fj=fj) is P (inspection item behavior failure mode) having been read at the processing step S800 and it is assumed that J pieces of P in total have been read in equation (6). Note that P (Fj=fj) is P (failure mode) having been read at the processing step S810 and it is assumed that K pieces of P in total have been read. The value fj takes “1” (True) if the failure mode occurs and “0” (False) if the failure mode does not occur. The value ik indicates an inspection result and takes “1” (True) if the inspection item behaves as described for the inspection item behavior and “0” (False) otherwise. This information “0” or “1” is acquired by referring to the inspection result D14 in FIG. 4.

Note that the equations above are derived using conventional Bayesian network techniques called Bayesian network factorization and Noisy-OR. When calculating equation (5) is done, the processing step S820 terminates and a transition is made to a processing step S840.

The processing step S840 is to calculate the probability of a j-th failure mode as expressed in equation (8) that reflects inspection results from the simultaneous probability obtained at the processing step S820. This can be done by calculating equation (9) below.

$$\begin{matrix}P ( {F}_{1} = {f}_{1} , {F}_{2} = {f}_{2} , … , {F}_{j} = {f}_{j} , {I}_{1} = {i}_{1} , {I}_{2} = {i}_{2} , … , {I}_{k} = {I}_{k} ) & ( 7 ) \\ P ( {F}_{j} = {f}_{j} / {I}_{1} = {i}_{1} , {I}_{2} = {i}_{2} , … , {I}_{k} = {I}_{k} ) & ( 8 ) \\ P ( {F}_{j} = {f}_{j} / {I}_{1} = {i}_{1} , {I}_{2} = {i}_{2} , … , {I}_{k} = {I}_{k} ) = \frac{\begin{matrix}{\sum }_{i \neq j}^{K} {\sum }_{{f}_{i} = 0}^{{f}_{i} = 1} P ( {F}_{1} = {f}_{1} , {F}_{2} = {f}_{2} , … , \\ {F}_{j} = {f}_{j} , {I}_{1} = {i}_{1} , {I}_{2} = {i}_{2} , … , {I}_{k} = {i}_{k} )\end{matrix}}{\begin{matrix}{\sum }_{i = 1}^{K} {\sum }_{{f}_{i} = 0}^{{f}_{i} = 1} P ( {F}_{1} = {f}_{1} , {F}_{2} = {f}_{2} , … , \\ {F}_{j} = {f}_{j} , {I}_{j} = {i}_{j} , {I}_{2} = {i}_{2} , … , {I}_{k} = {i}_{k} )\end{matrix}} & ( 9 )\end{matrix}$$

This equation means a conditional probability by which a j-th failure mode Fj=fj occurs when inspection results of inspection items I1 to Ik are it to ik. This is the failure mode probability that is estimated from the inspection results. The subroutine in FIG. 6 returns the probability obtained by equation (9) and terminates. Processing returns to the processing step S710 in FIG. 5 and proceeds to a processing step S715.

The processing step S715 in FIG. 5 is to calculate a posterior variance of, as variability of equation (9) calculated at the processing step S710, thus calculating uncertainty of the calculation result. Particularly, a calculation is made of variance about the failure mode estimated to have the highest probability as a result of equation (9). For this calculation, it is needed to treat P (Ik=ik/Fj=fj) and P (Fj=fj) in the equations as a random variable that varies randomly, instead of a constant, and calculate equation (6) and equation (9).

Here, treating P (Ik=ik/Fj=fj) as a random variable has a meaning described below. For example, in the first row of the inspection item probability table DB2 in FIG. 2, the inspection item occurrence probability D25, P (inspection item behavior failure mode) is a constant of “0.30”; actually, however, there is variability around the constant. When equations (6) and (9) are calculated on the presumption that probability varies somewhat, variance of equation (9) is calculated.

A concrete algorithm is described below. First, assuming that variability of P (Ik=ik/Fj=fj) follows the beta distribution as expressed in equation (4), this can be expressed as in equation (10). Here, it is assumed that θjk=P (Ik=ik/Fj=fj).

$${θ}_{jk} ∼ Beta ( {e}_{jk} , {p}_{jk} ) = \frac{1}{θ ( {e}_{jk} {p}_{ik} , {e}_{jk} ( {p}_{jk} - 1 ) )} {{x}^{{e}_{jk} {p}_{jk} - 1} ( I - x )}^{{e}_{jk} ( {p}_{jk} - 1 ) - 1} \qquad ( 10 )$$

Here, ejk is Experience (e.g., “100” described in the field D26 in the first row of the inspection item probability table DB2 in FIG. 2) and Pjk is an expected value of probability (e.g., “0.30” described in the field D25 in the first row of the inspection item probability table DB2 in FIG. 2). Because the smaller Experience, reliability will be lower, equation (10) gives a distribution with large variability.

Likewise, variability of P (Fj=fj) can be expressed as in equation (11). Here, it is assumed that φj=P (Fj=fj).

$${φ}_{j} ∼ B e t a ( {e}_{j} , {p}_{j} ) = \frac{1}{B ( {e}_{j} {p}_{j} , {e}_{j} ( {p}_{j} - 1 ) )} {{x}^{{e}_{j} {p}_{j} - 1} ( 1 - x )}^{{e}_{j} ( {p}_{j} - 1 ) - 1} \qquad ( 11 )$$

Then, variance can be obtained by calculating variance of equation (9), assuming that P (Ik=ik/Fj=fj) and P (Fj=fj) in equations (6) and (9) follow equations (10) and (11) respectively.

A processing step S725 in FIG. 5 is to evaluate the variance of the probability of the failure mode with the highest probability calculated at the processing step S715. If the variance is less than a threshold, the estimation accuracy is regarded as sufficient and a transition is made to a processing step S740. Here, the threshold is a design item that determines an allowable level of uncertainty of the accuracy from operational requirements. Additionally, if the number of times of additional inspection items that will be inspected from now on has exceeded an upper bound value, a transition is also made to the processing step S740. This is also a design item that determines a maximum allowable number of times that additional items can be inspected from operational requirements.

As a result of decision at the processing step S725, if the variance of the probability of the failure mode with the highest probability calculated at the processing step S715 is equal to or more than the threshold, the estimation accuracy is regarded as insufficient and a transition is made to a processing step S730.

The processing step S730 is to search for and present additional inspection items to secure the accuracy of failure mode estimation. As for a failure mode with a low accuracy of estimation accuracy, this processing prompts a maintenance person to perform inspection newly at the opportunity of inspection when he or she is going to perform inspection to reflect its result in processing that will be performed from now.

A subroutine (SUB02) that represents detailed processing contents of the processing step S730 in FIG. 5 is described below with a flowchart in FIG. 7. A processing step S900 is to search for inspection items that are linked with the failure mode with the highest probability found at the processing step S710. This can be done by specifying the appropriate failure mode D21 in FIG. 2 as a key and searching for inspection items D23 liked with the failure mode D21.

A first processing step S905 in FIG. 7 is to perform processing to narrow the inspection items D23 resulting from the processing step S900 down to inspection items that have not yet been inspected by the maintenance person 102. As for judging whether an inspection item has not yet been inspected, an inspection item is judged uninspected, if its record is not found under the header, inspection item D12 of the table of the temporary storage unit DB1 in FIG. 4.

FIG. 10 presents a display screen example 90B displaying uninspected inspection items obtained as a result of processing at the processing step S905. In this case, uninspected inspection items are displaced, positioned as additional inspection item candidates. All uninspected items at this stage may be subject to new inspection. In the present embodiment, they are narrowed down to inspection items that have a higher degree of certainty of the necessity for inspection through further processing and decision below.

A processing step S910 is to calculate a quantity of mutual information between each of the uninspected inspection items D12 obtained at the processing step 905 and a failure mode D11 that is liked with it. A quantity of mutual information M is a value indicating how accurate the occurrence probability of the failure mode D11 is known when the result of the inspection item D12 has been known.

The quantity of mutual information M can be calculated using equation (12) from P (Ik=ik/Fj=fj) corresponding to D25 (inspection item occurrence probability) in the inspection item probability table DB2 in FIG. 2 and P (Fj=fj) corresponding to D32 (occurrence probability P (failure mode)) in the failure mode probability table DB3 in FIG. 3. Note that j is a fixed value because Fj is confined to a variable indicating the failure mode with the highest probability.

$${M}_{jk} = {Σ}_{{{i}_{k} = 0 , 1}_{{f}_{j} = 0 , 1}} P ( {I}_{k} = {i}_{k} , {F}_{j} = {f}_{j} ) log \frac{P ( {I}_{k} = {i}_{k} , {F}_{j} = {f}_{j} )}{P ( {I}_{k} = {i}_{k} ) P ( {F}_{j} = {f}_{j} )} \qquad ( 12 )$$

Here, there are relationships as in equations (13) and (14) below.

$$\begin{matrix}P ( {I}_{k} = {i}_{k} , {F}_{j} = {f}_{j} ) = P ( {I}_{k} = {i}_{k} \vert {F}_{j} = {f}_{j} ) P ( {F}_{j} = {f}_{j} ) & ( 13 ) \\ P ( {I}_{k} = {i}_{k} ) = {\sum }_{{f}_{j} = 0 , 1} P ( {I}_{k} = {i}_{k} , {F}_{j} = {f}_{j} ) & ( 14 )\end{matrix}$$

A processing step S950 in FIG. 4 is to find inspection items with high quantities of mutual information at top N ranks from among quantities of mutual information Mjk calculated by equation (12) at the processing step S910. This corresponds to finding k that makes Mjk high in terms of equation (12). This can be done by simply evaluating all possible values of k and finding multiple values of k placed at 1 to N ranks in descending order.

Although uninspected inspection items are displayed, positioned as additional inspection item candidates in the display screen 90B at an intermediate stage, inspection items selected from a perspective of high quantities of mutual information are displayed as additional inspection item candidates along with other pieces of information in a display careen 90C which is presented in FIG. 11 after the processing at the processing step S950.

The display careen 90C presented in FIG. 11 is comprised of left and right display regions. A list of inspection item candidates is presented in the left display region and failure mode candidates with top ranks of occurrence probability are presented in descending order of probability in the right display region.

The left display region in FIG. 11 has a structure in which, in addition to the same list of inspection items as displayed in FIG. 9, inspection items selected from the perspective of high quantities of mutual information from the additional inspection item candidates displayed in FIG. 10 are separately displayed in an area inside bold lines 1142 and described additionally as additional inspection item candidates.

The right half of the screen in FIG. 11 presents failure mode candidates with top ranks of occurrence probability in descending order of probability. Here, the failure mode candidates are defined with a field of failure mode D41A, a field of probability D42A, a field of occurrence probability D43A, and related equipment/component to be inspected D44A. In the field of occurrence probability D43A, standard deviation of the occurrence probability of a failure mode is described. This standard deviation is a root value of the “variance of the probability of the failure mode with the highest probability” calculated at the processing step S715.

Let us look at a first row in the right half of the screen in FIG. 11. When the failure mode D41 is “evaporator coolant decrease”, its probability D42 is 70%, the highest in the table, whereas the standard deviation of its occurrence probability D43 is ±30% which is quite a large value, indicating that the resultant probability is not much reliable.

In the related equipment/component to be inspected D44A, reference information should preferably be described. As reference information, for example, information of equipment/components to be inspected liked with the failure mode D41A (in this example, “evaporator inlet temperature” and “power supply input voltage”) is presented in the related equipment/component to be inspected D44A. Equipment/components to be inspected liked with the failure mode D41A that should be presented in the related equipment/component to be inspected D44A can be obtained by searching for those liked with the failure mode from the fields D21, D22, and D23 in FIG. 2. Then, the subroutine SUB02 terminates and processing returns to the processing step S730 and then proceeds to a processing step S735.

The processing step S735 is to prompt the maintenance person 102 to enter inspection results in the area inside bold lines 1142 in the screen in FIG. 11 to increase the reliability of occurrence probability D43. After that, processing returns to the processing step S710 and executes a recalculation of the failure mode with the highest probability based on the inspection results entered at the processing step S735. A loop described above continues until the standard deviation D43 of failure probability becomes less than the threshold at the processing step S725 and it is decided that the reliability of the probability D42 is secured or the number of inspection items has exceeded the upper bound.

Then, processing from the processing step S740 after exiting the loop at the processing step S725 is described. The processing step S740 is to present failure modes with top N ranks of probability for which the reliability is secured on a display screen 90D as is presented in FIG. 12. FIG. 12 is an example where those at top three ranks are displayed. Number N should be determined depending on the screen size or the like at the time of designing the system of the present invention. In the columns of D41A, D42A, D43A, and D44A, pieces of information corresponding to those in the table in the right half of the screen in FIG. 12 are presented. However, deviation of probability D43 is reduced to 5% because of additional inspection items done and the reliability of failure probability is improved than a value displayed in the corresponding field in FIG. 11.

A processing step S745 is the one in which the maintenance person 102 selects each one of the failure modes in top ranks N of occurrence probability presented at the processing step S740 and takes action on the failure mode selected. No processing is performed in the system of the present invention.

A processing step S750 is to prompt the maintenance person 102 to enter what is a failure mode judged true as a result of the action taken and update Experience and probability information based on what has been entered. Subroutine processing SUB03 that represents detailed contents of the processing step S750 is described with FIG. 8.

A processing step S400 in FIG. 8 is to prompt the maintenance person 102 to enter a failure mode. This can be done by prompting the maintenance person to check the checkbox of a failure mode judged true in a field of check mark input D40A in FIG. 12. After the checking, the maintenance person sends information of the inspection results entered at the processing steps S705 and S735 and the failure mode judged true to the center system 150 by pressing a Transmit button 1242.

A processing step S410 is to update the values of probability D25, D32 and Experience D26, D33 in FIG. 2 and FIG. 3 from the inspection results entered until now by the maintenance person 102 and the failure mode judged true entered at the processing step S400. Although this is a Bayesian updating technique in a conventional technique, a case of updating the failure mode probability table in FIG. 3 is described briefly.

Taking e for Experience D26 and p=occurrence probability P (failure mode) for Experience D33, updating equations are expressed as equations (15) and (16) below.

e→e+1 (15)

p→(ep+1)/(e+1) (16)

For example, if the failure mode is “condenser coolant decrease” in the first row in FIG. 3, the above equations are transformed to equations (17) and (18) below.

e→10+1=11 (17)

p→(10×0.05+1)/(10+1)≈0.136 (18)

Upon the completion of updating these values, the subroutine processing SUB03 terminates and processing returns to the processing step S750, then the processing in the present embodiment is complete.

A concept underlying the present invention described hereinbefore is, in short, as follow. If a failure mode is doubtful because of less frequency of its occurrence and low accuracy of estimation, the system instructs an on-site maintenance person to perform additional inspection items to secure the estimation accuracy. Also, when doing so, by prompting the maintenance person to make an entry of inspection results and gathering information of inspection items, the system makes it possible to increase the estimation accuracy without additional inspections from now on. Thereby, according to the present invention, the accuracy of estimating a failure mode of equipment is improved and frequency of replacement operations, a time of examination, and a recovery time of equipment from a failure are decreased.

### REFERENCE SIGNS LIST

1: maintenance recommendation system
102: maintenance person
104: equipment
100: terminal
105: display unit
120: input unit
125: communication unit
150: center system
170: probability updating unit
175: failure mode probability calculating unit
190: communication unit
195: estimation-accuracy determining unit
200: additional inspection item searching unit
DB1: temporary storage unit
DB2: inspection item probability table
DB3: failure mode probability table

What is claimed is:

1. A maintenance recommendation system for identifying a failure mode of a machine, the system comprising:
an information input element to input one or more inspection results required to identify a failure mode;
a temporary storage unit to store the inspection results;
a failure mode probability calculating unit to estimate probabilities of failure modes from results of inspection performed one or more times; and
an estimation-accuracy determining unit to calculate uncertainty of the probabilities of the failure modes,
wherein the system presents inspection items based on the uncertainty of the probabilities of the failure modes.

2. The maintenance recommendation system according to claim 1,
wherein the system estimates the uncertainty of the probabilities of the failure modes from failure data ever gathered.

3. The maintenance recommendation system according to claim 1,
wherein the system presents the inspection items when a probability of a failure mode is decided to be uncertain.

4. The maintenance recommendation system according to claim 1,
wherein the system preferentially presents inspection items that are more effective for narrowing down the failure modes among inspection items to be presented.

5. The maintenance recommendation system according to claim 1,
wherein the system learns inspection items to be presented and failure modes that has actually occurred.

6. A maintenance recommendation system for identifying a failure mode of a machine, the system comprising:
a terminal; and
a center system that is connected with the terminal via communications,
wherein the terminal includes:
a display unit;
an input unit; and
a communication unit,
wherein the center system includes:
an information input unit to input, via the communication unit, one or more inspection results required to identify a failure mode, the inspection results being input through the input unit of the terminal;
a temporary storage unit to store the inspection results;
a failure mode probability calculating unit to estimate probabilities of failure modes from results of inspection performed one or more times; and
an estimation-accuracy determining unit to calculate uncertainty of the probabilities of the failure modes, and
wherein the terminal inputs, via the communication unit, inspection items obtained based on the uncertainty of the probabilities of the failure modes in the center system and displays the inspection items on the display unit.

7. A maintenance recommendation method for identifying a failure mode of a machine, the method comprising the steps of:
estimating probabilities of failure modes from one or more inspection results required to identify a failure mode;
calculating uncertainty of the probabilities of the failure modes; and
presenting inspection items which have a high degree of the uncertainty of the probabilities of the failure modes, thereby prompting a person to inspect the inspection items which have a high degree of the uncertainty of the probabilities of the failure modes.
